(19) United States
(12) Patent Application Publication
(10) Pub. No.: US 2007/0287410 A1
(43) Pub. Date: Dec. 13, 2007

(54) Position location system and method for mobile terminal

(75) Inventors: Jong Cheol Bae, Metropolitan City (KR); Soon Jin Kim, Metropolitan City (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/652,081

(22) Filed: Jan. 11, 2007

(30) Foreign Application Priority Data
Jun. 8, 2006 (KR) 2006-0051389

(51) Int. Cl. H04M 11/04

(52) U.S. Cl. 455/404.2

(57) ABSTRACT

A position location system and method for a mobile terminal in a mobile communication system are provided. The position location method for a mobile communication system in which a calling mobile terminal communicates with a called mobile terminal through at least one network, includes obtaining, at the network, position data of the called mobile terminal during a call setup, generating position information on the basis of the position data, transmitting the position information from the network to the calling mobile terminal, receiving, at the calling mobile terminal, the position information and outputting the position information as an announcement message.

### CROSS REFERENCE TO RELATED APPLICATIONS

This application claims the benefit under 35 U.S.C. §119(a) of Korean Patent Application No. 2006-0051389, which was filed in the Korean Intellectual Property Office on Jun. 8, 2006, the entire disclosure of which is hereby incorporated by reference.

### BACKGROUND OF THE INVENTION

1. Field of the Invention

The present invention relates to a mobile communication system. More particularly, the present invention relates to a position location system and method for a mobile terminal in a mobile communication system.

2. Description of the Related Art

Recent advances in wireless communication and mobile terminals have made possible the broad distribution of multimedia contents and the expansive utilization of mobile terminals.

To keep pace with the technical advances, mobile terminals such as cellular phones are becoming equipped with additional modules such as a camera, camcorder, global positioning system (GPS) module, and the like for supporting various entertainment and practical services.

Among them, a position-location service provides a subscriber's location to within 50 meters in open areas, offering security for high-risk individuals such as children and the elderly.

In the position-location service, a user accesses a website provided by a tracking service center through a mobile terminal and provides the website with information for authentication. The user also provides information on a counterpart mobile terminal such as a subscriber ID, phone number, and the like.

If the user is authorized, the tracking service center locates the position of the counterpart mobile terminal and provides the position information to the user.

In the conventional position-location service, however, the user is required to make inconvenient key manipulation to obtain the position information of the counterpart mobile terminal.

Also, the conventional position-location service has the drawback that it may take a long time to obtain the position location result, or may obtain no result at all in the worst case, depending on the traffic condition on Internet, because the user must utilize the Internet in addition to an access network for accessing the website.

Further, since the conventional web-based position-location service requires use of both the access network and Internet, the service cost is increased due to the occupancy of two network resources, especially when the traffic condition is bad on Internet, resulting in degradation of subscription for the position-location service.

Accordingly, there is a need for an improved system and method for position location of a mobile terminal.

### SUMMARY OF THE INVENTION

Exemplary embodiments of the present invention have been made in an effort to address the above problems and/or disadvantages and provide at least the advantages described below. Accordingly, it is an exemplary object of the present invention to provide a system and method for position location of a target mobile terminal, the system and method being capable of simplifying manipulation for obtaining position information of the target mobile terminal.

It is another object of the present invention to provide a system and method for position location of a mobile terminal wherein the system and method are capable of obtaining position information from a counterpart mobile terminal without engagement of the Internet.

It is another exemplary object of the present invention to provide a system and method for position location of a mobile terminal wherein the system and method are capable of obtaining position information of a target mobile terminal in a call setup stage.

It is another exemplary object of the present invention to provide a system and method for position location of a mobile terminal wherein the system and method are capable of setting transmission and reception of position information.

In accordance with an exemplary aspect of the present invention, the above and other objects are accomplished by a position location method for a mobile communication system in which a calling mobile terminal communicates with a called mobile terminal through at least one access network. The position location method includes obtaining, at the network, position data of the called mobile terminal during a call setup, generating a position information on the basis of the position data, transmitting the position information from the network to the calling mobile terminal, receiving, at the calling mobile terminal, the position information, and outputting the position information as an announcement message.

In accordance with another exemplary aspect of the present invention, the above and other objects are accomplished by a position location method for a mobile communication system in which a calling mobile terminal communicates with a called mobile terminal through at least one access network. The position location method includes requesting, at the calling mobile terminal, a call to the called mobile terminal, receiving position information of the called mobile terminal and outputting the position information as an announcement message.

In accordance with another exemplary aspect of the present invention, the above and other objects are accomplished by a position location method for a mobile communication system in which a calling mobile terminal communicates with a called mobile terminal through at least one access network. The position location method includes receiving, at the called mobile terminal, a position request message from the calling mobile terminal and transmitting position information to the calling mobile terminal in response to the position request message.

In accordance with another exemplary aspect of the present invention, the above and other objects are accomplished by a position location system. The position location system includes a calling mobile terminal which transmits a call request message to another terminal for communication, a called mobile terminal which transmits a connection establishment message for establishing the communication in response to the call request message and a network for obtaining position data of the called mobile terminal upon receiving the call request from the calling mobile terminal, generating position information on the basis of the position data, and transmitting the position information to the calling mobile terminal, wherein the calling mobile terminal receives the position information, generates a position announcement message on the basis of the position information, and outputs the position announcement message.

### BRIEF DESCRIPTION OF THE DRAWINGS

The above and other objects, features and advantages of the present invention will be more apparent from the following detailed description in conjunction with the accompanying drawings, in which:

FIG. 1 is a schematic view illustrating a cellular communication system to which a position location system and method according to an exemplary embodiment of the present invention are applied;

FIG. 2 is a block diagram illustrating a configuration of a mobile terminal according to an exemplary embodiment of the present invention;

FIG. 3 is a message flow diagram illustrating a position location method for a mobile terminal according to an exemplary embodiment of the present invention;

FIG. 4 is a flowchart illustrating a position location method according to an exemplary embodiment of the present invention in a calling mobile terminal; and

FIG. 5 is a flowchart illustrating a position location method according to an exemplary embodiment of the present invention in a called mobile terminal.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention and are merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness. Exemplary embodiments of the present invention are described with reference to the accompanying drawings in detail.

Exemplary embodiments of the present invention are shown in drawings and will be described herein in detail, with the understanding that the present disclosure is to be considered as an exemplification of the principles of the invention and is not intended to limit the invention to the exemplary embodiments illustrated.

For clarity and conciseness, the exemplary embodiments are described using a mobile terminal as an example of portable device. However, the mobile terminal can be replaced by a cellular phone, personal communication service (PCS) phone, dedicated DMB receiver, smart phone, International Mobile Telecommunication 2000 (IMT-2000) terminal, Universal Mobile Telecommunication Service (UMTS) terminal, laptop computer, personal computer, and the like.

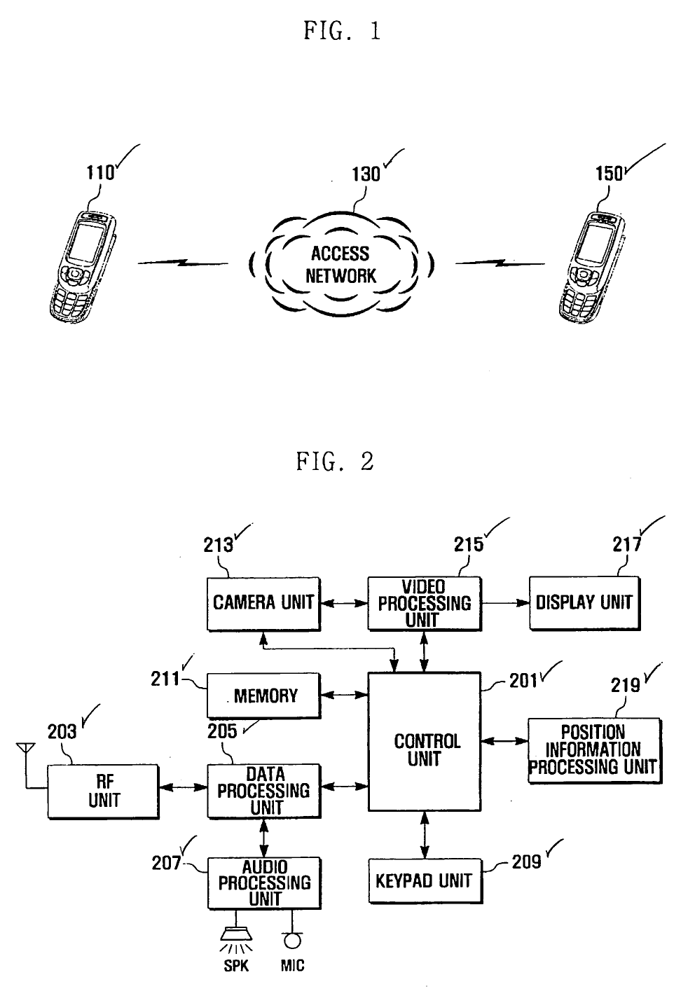

FIG. 1 is a schematic view illustrating a cellular communication system to which a position location system and method according to an exemplary embodiment of the present invention-are applied.

Referring to FIG. 1, a cellular communication system includes an access network 130, and a plurality of mobile terminals 110 and 150 communicating with each other through the access network 130.

Assuming that a calling mobile terminal 110 places a call to mobile terminal 150, the calling mobile terminal 110 obtains the position information of the called mobile terminal 150 during a call setup procedure.

That is, the calling mobile terminal 110 transmits a call request message to the called mobile terminal 150 through the access network 130, the called mobile terminal 150 transmits information on a current position in response to the call request message, whereby the calling mobile terminal 110 outputs the position information of the called mobile terminal 150 in the form of a voice or text message with or without a map displayed around the position of the called mobile terminal 150.

Upon receiving the call request message from the calling mobile terminal 110, the access network 130 generates a position request message in accordance with the call request message and transmits the position request message to the called mobile phone 150. The position request message can be incorporated and transmitted with a call establishment message for establishing the call or can be transmitted separately before the call establishment message.

If the position request message is received, the called mobile terminal 150 transmits an acknowledgment message in response to the position request message to the access network 130. The acknowledgement message contains position information of the called mobile terminal 150. However, the acknowledgement message does not contain the position information if the called mobile terminal 150 is set to reject the position request.

In an exemplary embodiment, the access network includes at least one Base Station (BS), a Base Station Controller (BSC), a Mobile Switching Center (MSC), and a Home Location Register (HLR). In addition, the access network 130 can include GPS for positioning the mobile terminal. Of course, the access network can include an accounting element charging for the position location service.

The access network 130 can be implemented with Code Division Multiple Access (CDMA), Frequency Division Multiple Access (FDMA), Time Division Multiple Access, Wideband CDMA (WCDMA), Orthogonal Frequency Division Multiple Access (OFDMA), and the like.

In an exemplary embodiment, the access network 130 can be implemented as a CDMA or IEEE 802.1x network, an overlay network of the CDMA or IEEE 802.1x networks, and the like.

In addition, the access network 130 establishes traffic channels, data channels, paging channels, and the like, to mobile terminals 110 and 150.

The operation of the above structured position location system is described as follows.

When the calling mobile terminal 110 transmits a call request with an identifier of the called mobile terminal 150 to the access network 130, the access network 130 locates a position of the called mobile terminal using the identifier of the called mobile terminal 150 and information on a base station with which the called mobile terminal 150 is currently associated or GPS.

Subsequently, the access network 130 transmits the information on the position of the called mobile terminal 150 to the calling mobile terminal 110. In such a manner, the calling mobile terminal 110 can obtain the position information of the called mobile terminal 150 during the call setup.

The signaling procedure between the calling mobile terminal 110 and the wireless access network 130 can be performed in various manners for informing the caller of the position of the called mobile terminal 150.

For example, the access network 130 may generate a position announcement message corresponding to the position of the called mobile terminal 150 and transmit the position announcement message to the calling mobile terminal 110 in place of a normal ring-back tone before the call is answered. Accordingly, the calling mobile terminal 110 receives the position announcement message and plays the position announcement message to the caller (for example, 00 station, 00 Hospital, 00 park, and the like).

The access network 130 also can transmit the position information as a coordinate to the calling mobile terminal 110. In an exemplary embodiment, the calling mobile terminal 110 receives the coordinate, generates a coordinate announcement message or a position announcement message previously mapped to the coordinate, and plays the announcement message to the caller.

The access network 130 also can generate a coordinate announcement message mapped to a coordinate of the called mobile terminal 150 and transmit the coordinate announcement message to the calling mobile terminal 110. In an exemplary embodiment, the calling mobile terminal 110 receives the coordinate announcement message and plays the coordinate announcement message to the caller.

Upon receiving the call request message from the calling mobile terminal 110, the access network 130 generates a position request message in accordance with the call request message and transmits the position request message to the called mobile terminal 150. In response to the position request message, the called mobile terminal 150 transmits the position information to the access network 130 when the called mobile terminal 150 is set to provide the position information. The position of the called mobile terminal 150 can be located periodically or upon receiving the position request message.

The position information can be transmitted in accordance with the called mobile phone user's manual operation. In an exemplary embodiment, the called mobile phone 150 presents an announcement message notifying the request of the position information on a display screen such that the called mobile phone 150 determines whether to transmit the position information according to the user's manipulation.

FIG. 2 is a block diagram illustrating a configuration of a mobile terminal according to an exemplary embodiment of the present invention.

Referring to FIG. 2, the mobile terminal includes an input means, a processing means, a storage means, an output means, and a communication means.

The input means includes an audio processing unit 207, a keypad unit 209 for allowing the user to input alphanumeric data, and a camera unit 213 for taking pictures. A display unit 217 is also provided and may be implemented as a liquid crystal display (LCD). In the case that the display unit 217 supports a touchscreen function, the display unit 217 can be included in the input means. The input means is responsible for obtaining various data such as voice data, alphanumeric data, and video data through the elements constituting the input means.

The processing means includes a video processing unit 215 for converting analog signals of the picture taken by the camera unit 213 into digital video signals, a position information processing unit 219 for extracting a coordinate or a position announcement message from position information received from a called mobile terminal, a data processing unit 205 for processing audio signals output from the audio processing unit 207 and key input signals generated through the keypad unit 209, and a control unit 201 for controlling overall operation of the mobile terminal.

Storage means stores user data such as a text document, a picture taken by the camera unit 213, and an application program for controlling the operations of the mobile terminal for locating the position of the called mobile terminal. The storage means includes a memory 211.

The output means includes the display unit 217 for displaying user input information and application data generated by the application program for locating the position of the called mobile terminal. The output means also includes the audio processing unit 207 for outputting audio data and the position announcement message.

The communication means includes an RF unit 203, which communicates with a web server through at least an antenna. The RF unit 203 can support various types of communication services such as cellular or other wireless communications. The RF unit 203 includes an RF transmitter for up-converting and amplifying a signal to be transmitted and an RF receiver for low-noise-amplifying and down-converting a received signal.

The data processing unit 205 processes audio data input through the audio processing unit 207 and alphanumeric data input through the keypad unit 209. The data processing unit 205 also includes a means for encoding and modulating a signal to be transmitted through the RF unit 203 and a means for demodulating and decoding a signal received through the RF unit 203. In addition, the data processing unit is provided with a codec pack for supporting encoding and decoding the video and audio data.

The audio processing unit 207 processes the audio signal from the data processing unit 205 so as to be output through a speaker and transfers the audio signal input through a microphone to the data processing unit 205.

The keypad unit 209 includes a plurality of alphanumeric keys for enabling a user to input alphanumeric characters and various function keys enabling the user to input commands for operating corresponding functions. The keypad unit 209 allows the user to input alphanumeric data and instructions for performing operations, especially associated with the position locating application.

The memory 211 includes a program memory and a data memory. The program memory stores programs for controlling the general operations of the portable phone and application programs for locating the position of the called mobile terminal.

The data memory temporarily stores the data generated during the operations of the programs and a database for arranging the data in the form of a table.

The camera unit 213 takes a picture and converts the picture of analog signals into video signals in interoperation with an encoder (not shown). The video processing unit 215 converts video signals from the camera into image signal such that the image signals are processed to be appropriate for the display unit 217.

The video processing unit 215 processes the application data image and menu screen image to be suitable for the display unit 217 and then transmits the processed images to the display unit 217 under the control of the control unit 201. The application data image includes a position notification message and a map around the position of the called mobile terminal generated by the position locating application.

The video processing unit 215 is provided with a function for compression/decompression of the video data and at least one video codec. The video codec includes a JPEG codec, a MPEG4 codec, Wavelet codec, and the like.

The display unit 217 presents the video data output from the video processing unit 215. The display unit 217 also presents the application data generated by the position locating application. In addition, the display unit 217 can present the menu screen for operating the position location application according to the user's manipulation.

The application data includes a text message notifying the caller of the position of the called mobile terminal and a local map around the position of the called mobile terminal, the map being generated by the position locating application referring to previously stored map data.

The position information processing unit 219 processes information on the position of the called mobile terminal under the control of the control unit. For example, the position information processing unit 219 extracts the coordinate from the position information and generates a position announcement message, in text or voice, for notifying the position of the called mobile terminal on the basis of the coordinate. The position announcement message can be presented together with a local map around the position of the called mobile phone.

The control unit 201 controls the overall operations of the mobile phone, in other words, the cooperation of the data processing unit 205, keypad unit 209, memory 211, camera unit 213, video processing unit 215, and position information processing unit 219.

The control unit 201 controls the position information processing unit 219 to process the position information received from the called mobile terminal and outputs the position information in a form. The control unit 201 also controls to transmit position information if a position request message is received from a calling mobile terminal.

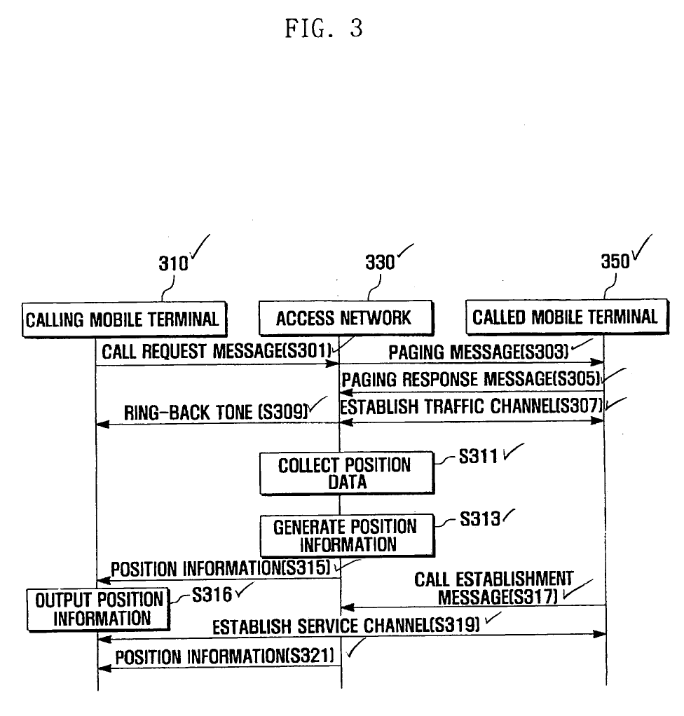

FIG. 3 is a message flow diagram illustrating a position location method for a mobile terminal according to an exemplary embodiment of the present invention.

Referring to FIG. 3, a calling mobile terminal 310 transmits a call request message to an access network 330 for establishing a communication link with a called mobile terminal 350 (S301). Upon receiving the call request message, the access network 330 broadcasts a paging message in order to contact the called mobile terminal 350 (S303).

When the paging message is received, the called mobile terminal 350 transmits a paging response message in response to the paging message (S305).

Upon receiving the paging response message, the access network 330 establishes a traffic channel with the called mobile terminal 350 (S307). While negotiating with the called mobile terminal for establishing the traffic channel, the access network 330 transmits a ring-back tone to the calling mobile terminal 310 (S309).

Subsequently, the access network 330 collects position data of the called mobile terminal 350 by means of GPS or using information on a base station with which the called mobile terminal is associated (S311).

After collecting the position data, the access network generates position information on the basis of the position data of the called mobile terminal (S313), and then transmits the position information of the called mobile terminal to the calling mobile terminal (S315). The position information can be transmitted in a form of text or voice announcement message.

Upon receiving the position information from the access network 330, the calling mobile phone 310 outputs the received position information in a manner suitable for informing the caller of the position of the called terminal 350 (S316).

If the access network 330 transmits the position information as a voice announcement message, the calling mobile terminal 310 replays the voice announcement message for notifying the position of the called terminal 350.

If the access network 330 transmits the position information as a text announcement message, the calling mobile terminal 310 presents the text announcement message on a display. In an exemplary embodiment, it is also possible that the calling mobile terminal 310 converts the text announcement message into a voice announcement message and then replays the voice announcement message for notifying the position of the called mobile terminal 350.

If the access network 330 transmits the position information as a coordinate, the calling mobile terminal 310 presents the coordinate of the called mobile terminal on a local map together with position information corresponding to the coordinate.

In the meantime, if the access network 330 receives a call establishment request message from the called mobile terminal 350 (S317), the access network 330 establishes a service channel between the calling mobile terminal 330 and the called mobile terminal 350 (S319).

The establishment of the service channel can be failed if either of the two mobile terminals terminates or rejects the connection procedure.

The access network 330 can continuously collect the position data of the called mobile terminal 350 and periodically transmit the position information to the calling mobile terminal 310 during the communication session between the calling and called mobile terminals 310 and 350 (S321). Accordingly, the caller can monitor the movement of the called mobile terminal 350 in real time.

The calling mobile terminal 310 can notify the user of the position of the called mobile terminal 350 adaptive to the movement of the called mobile terminal as the text or voice announcement message, with or without a dynamically changing map.

In an exemplary embodiment, the location data is collected by the access network 330 without restriction. The position data collection procedure can be implemented such that the called mobile terminal can accept or reject to provide the position data in an automatic or manual manner.

As described above, the position of the called mobile terminal is provided to the calling mobile terminal as a coordinate, text, or voice announcement message with or without a map.

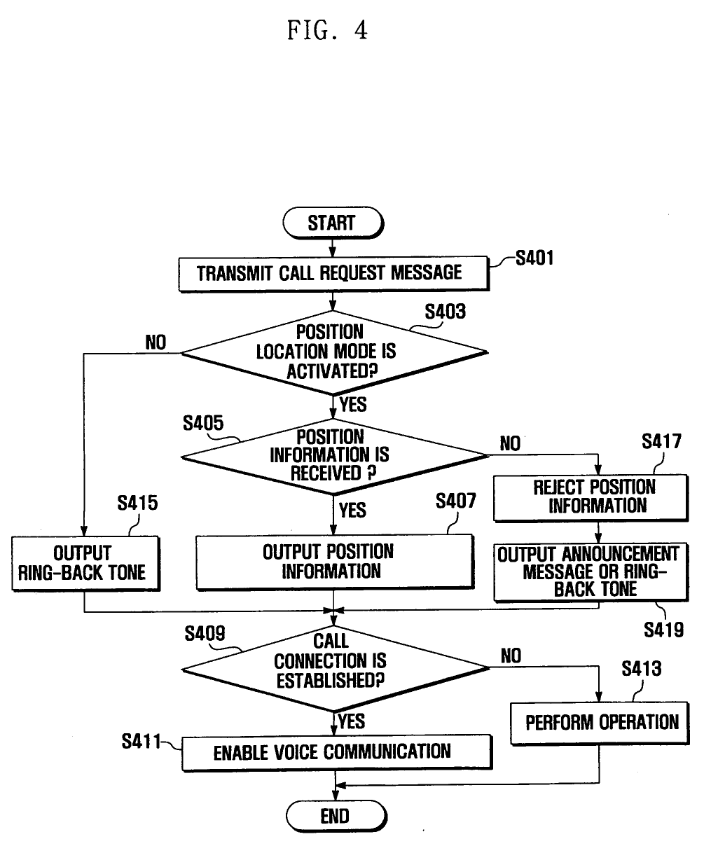

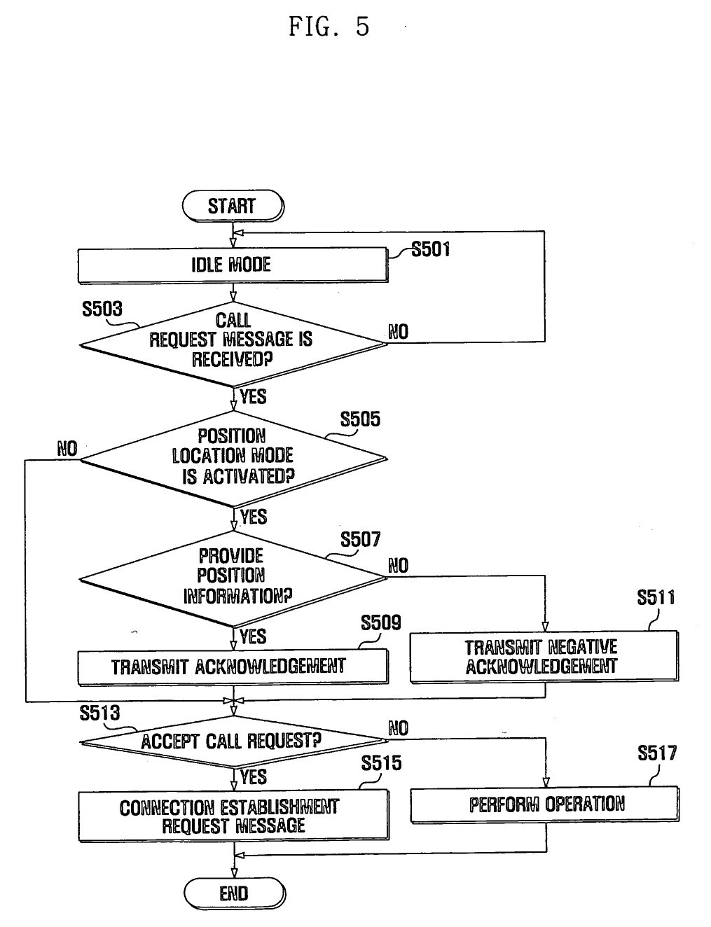

The above exemplary structured position location method is described now in more detail with reference to the accompanying FIGS. 4 and 5.

FIG. 4 is a flowchart illustrating a position location method according to an exemplary embodiment of the present invention in a calling mobile terminal.

Referring to FIG. 4, a calling mobile terminal transmits a call request message to an access network (S401) and determines whether a position location mode is activated (S403). The call request message includes a phone number or a network address of a called mobile phone.

If the position location mode is not activated, the calling mobile terminal outputs a ring-back tone received from the access network (S415).

If the position location mode is activated, the calling mobile terminal determines whether position information on the called mobile terminal is received from the access network (S405). If the position information is received from the access network, the calling mobile terminal outputs the received position information of the called mobile terminal (S407). If the position information is not received, the calling mobile terminal determines that a called mobile terminal rejects to provide the position information (S417). Subsequently, the calling mobile terminal outputs an announcement message for notifying the rejection and/or replays the ring-back tone (S419).

While replaying the ring-back tone at the step S415 and S419 or outputting the position information at step S407, the calling mobile terminal determines whether a call connection to the called mobile terminal is established (S409).

If the call connection is established, the calling mobile terminal enables voice communication with the called mobile terminal (S411). During the voice communication, the calling mobile terminal can receive the position information from the called mobile terminal and output the position information as a text or voice announcement message.

At step S409, if the call connection is not established, the calling mobile terminal performs an operation such as, for example, termination of a call setup procedure or retransmission of the call request message (S413). Even during the operation, it is possible for the calling mobile terminal to output the position information as the text or voice announcement message.

FIG. 5 is a flowchart illustrating a position location method according to an exemplary embodiment of the present invention in a called mobile terminal.

Referring to FIG. 5, during an idle mode (S501), a mobile terminal determines whether a call request message is received (S503).

If a call request message is received from a calling mobile terminal, the called mobile terminal determines whether a position location mode is activated (S505).

If the position location mode is not activated, the called mobile terminal determines whether to accept the call request from the calling mobile terminal (S513). In an exemplary embodiment, when the position location mode is disabled the called mobile terminal transmits a position information rejection message to the access network.

If the position location mode is activated at step S505, the called mobile terminal determines whether to provide position information to the calling mobile terminal (S507). In order to determine whether to provide the position information, the called mobile terminal presents a command selection screen for allowing a user to input a command.

If it is determined that the position information should be provided according to the user's command, the called mobile terminal transmits an acknowledgement message accepting the request for the position information to the access network (S509). Otherwise, the called mobile terminal transmits a negative acknowledgement message rejecting the request for the position information to the access network (S511).

After transmitting the acknowledgement or negative acknowledgement message, the called mobile terminal determines whether to accept the call request from the calling mobile terminal (S513).

If it is determined to accept the call request from the calling mobile terminal, the called mobile terminal transmits a connection establishment request message in response to the call request message transmitted by the calling mobile terminal and establishes a connection channel (S515).

If it is determined to reject the call request, the called mobile terminal performs an operation and terminates the call setup procedure (S517).

As described above, an exemplary position location system and method of the present invention allows a called mobile terminal to inform a caller of its current position during a call setup procedure, whereby it is possible to simplify locating a position of a target mobile terminal.

Also, an exemplary position location system and method of the present invention operate without engagement of the Internet and/or web-based menu navigation, resulting in reduction of complication and whole service cost.

Also, an exemplary position location system and method of the present invention allows the user to set a mobile terminal to output position information of the target mobile terminal in various manners, resulting in improvement of utilization of the position location service.

Further, an exemplary position location system and method of the present invention allows a called mobile terminal to determine whether to provide the position information, resulting in security of privacy.

Exemplary embodiments of the present invention can also comprise computer readable codes on a computer readable medium. The computer readable medium can comprise any data storage device that can store data that can be read by a computer system. Examples of a computer readable medium include magnetic storage media (such as, ROM, floppy disks, hard disks, among others), optical recording media (such as, CD-ROMs, or DVDs), and storage mechanisms such as carrier waves (such as, transmission through the Internet). The computer readable medium can also be distributed over network coupled computer systems so that the computer readable code is stored and executed in a distributed fashion.

Functional programs, codes, and code segments for accomplishing exemplary embodiments of the present invention can be construed by programmers of ordinary skill in the art to which the present invention pertains.

While the invention has been shown and described with reference to certain exemplary embodiments thereof, it will be understood by those skilled in the art that various changes in form and details may be made therein without departing from the spirit and scope of the invention as defined by the appended claims and the full scope of equivalents thereof

What is claimed is:

1. A position location method for a mobile communication system in which a calling mobile terminal communicates with a called mobile terminal through at least one access network, the method comprising:
obtaining, at a network, position data of a called mobile terminal during a call setup;
generating position information based on the position data;
transmitting the position information from the network to a calling mobile terminal;
receiving the position information by the calling mobile terminal; and
outputting the position information.

2. The method of claim 1, wherein the outputting of the position information comprises outputting the position information as an announcement message.

3. The method of claim 1, wherein the obtaining of the position data comprises obtaining position data based on at least one of an identifier of the network to which the called mobile terminal is associated and a global positioning system (GPS).

4. The method of claim 2, wherein the position information comprises at least one of a coordinate, text information, and voice information.

5. The method of claim 1, further comprising:
receiving the position data continuously from the called mobile terminal; and
periodically transmitting the position information to the calling mobile terminal.

6. The method of claim 4, wherein the outputting of the position information comprises presenting the announcement message with a map around the coordinate of the called mobile terminal.

7. The method of claim 4, wherein the outputting of the position information comprises at least one of:
converting the text information into a text announcement message; and presenting the text announcement message onto a display;
converting the text information into a voice announce message and playing the voice announcement message; and
converting the voice information into a voice announcement message and playing the voice announcement message.

8. The method of claim 1, wherein the outputting of the position information comprises:
generating a map around the position on the basis of the position information;
presenting the map on a display; and
highlighting the position of the called mobile terminal on the map.

9. A position location method for a mobile communication system in which a calling mobile terminal communicates with a called mobile terminal through at least one access network, the method comprising:
requesting a call to a called mobile terminal by a calling mobile terminal;
receiving position information of the called mobile terminal; and
outputting the position information.

10. The position location method of claim 9, wherein the outputting of the position information comprises outputting the position information as an announcement message.

11. The position location method of claim 9, wherein the receiving the position information comprises:
determining whether a position location function is activated;
receiving the position information if the position location function is activated; and
providing an indication if the position location function is not activated.

12. The position location method of claim 11, wherein the providing of the indication comprises playing a ring-back tone.

13. The position location method of claim 9, further comprising:
determining whether the position information is received within a time period;
generating an announcement message for notifying a position information rejection announcement message if the position information is not received in the time period; and
playing the announcement message.

14. The position location method of claim 13, wherein the playing of the announcement message further comprises playing a ring-back tone.

15. The position location method of claim 9, further comprising:
determining whether a session establishment request is received from the called mobile terminal;
establishing a communication session with the called mobile terminal if the session establishment request is received; and
receiving the position information during the communication session.

16. A position location method for a mobile communication system in which a calling mobile terminal communicates with a called mobile terminal through at least one access network, the method comprising:
receiving a position request message from a calling mobile terminal at a called mobile terminal; and
transmitting position information to the calling mobile terminal in response to the position request message.

17. The position location method of claim 16, further comprising:
determining whether a position location function is activated upon receiving the position request message;
transmitting a position request rejection message to the calling mobile terminal if the position location function is not activated; and
transmitting a position request acceptance message to the calling mobile terminal if the position location function is activated.

18. The position location method of claim 16, further comprising:
determining whether a position location function is activated upon receiving the position request message;
displaying a command input screen for allowing an input command to determine whether to transmit the position information if the position location function is activated;
transmitting a position request rejection message to the calling mobile terminal if a command is input for rejecting transmission of the position information; and
transmitting a position request acceptance message to the calling mobile terminal if a command is input for accepting transmission of the position information.

19. A position location system, comprising:
a calling mobile terminal which transmits a call request message to another terminal for communication;
a called mobile terminal which transmits a connection establishment message for establishing the communication in response to the call request message; and
a network for obtaining position data of the called mobile terminal upon receiving the call request from the calling mobile terminal, for generating position information on the basis of the position data, and for transmitting the position information to the calling mobile terminal,
wherein the calling mobile terminal receives the position information, generates a position announcement message on the basis of the position information, and outputs the position announcement message.

20. The position location system of claim 19, wherein the position data are obtained on the basis of at least one of an identifier of the network to which the called mobile terminal is associated and a global positioning system (GPS).

21. The position location system of claim 19, wherein each terminal comprises:
a radio frequency (RF) unit which performs up-converting on outgoing signals and down-converting on incoming signals;
a display unit for displaying the position information;
a position information processing unit for processing the position information and generating the position announcement message on the basis of the position information; and
a control unit for controlling operations of the RF unit, the display unit, and the position information processing unit.

22. The position location system of claim 21, wherein the display unit presents the position information comprising a map and the announcement message.

23. The position location system of claim 19, wherein the calling terminal comprises a memory for storing at least one application program for controlling operations for locating the position of the called mobile terminal.

24. The position location system of claim 21, wherein the calling terminal comprises a video processing unit for processing the position information for display on the display unit under the control of the control unit.

25. The position location system of claim 19, wherein the position information comprises at least one of a coordinate, text information, and voice information.

26. The position location system of claim 19, wherein the position data are continuously received from the called mobile terminal and the position information is periodically transmitted to the calling mobile terminal.

27. The position location system of claim 19, wherein the position announcement message is output with a map on which the position of the called mobile terminal is emphasized.

28. A computer readable medium having stored thereon instructions for executing a position location method for a mobile communication system in which a calling mobile terminal communicates with a called mobile terminal through at least one access network, the instructions comprising:
a first set of instructions for obtaining, at a network, position data of a called mobile terminal during a call setup;
a second set of instructions for generating position information based on the position data;
a third set of instructions for transmitting the position information from the network to a calling mobile terminal;
a fourth set of instructions for receiving the position information by the calling mobile terminal; and
a fifth set of instructions for outputting the position information.

29. The computer readable medium of claim 28, wherein the fifth set of instructions for outputting the position information comprise instructions for outputting the position information as an announcement message.

30. The computer readable medium of claim 28, wherein the first set of instructions for obtaining the position data comprise instructions for obtaining position data based on at least one of an identifier of the network to which the called mobile terminal is associated and a global positioning system (GPS).

31. The computer readable medium of claim 29, wherein the position information comprises at least one of a coordinate, text information and voice information.

32. The computer readable medium of claim 28, further comprising:
a sixth set of instructions for receiving the position data continuously from the called mobile terminal; and
a seventh set of instructions for periodically transmitting the position information to the calling mobile terminal.

33. The computer readable medium of claim 31, wherein the fifth set of instructions for outputting the position information comprise instructions for presenting the announcement message with a map around the coordinate of the called mobile terminal.

34. The computer readable medium of claim 31, wherein the fifth set of instructions for outputting the position information comprise at least one of:
instructions for converting the text information into a text announcement message and instructions for presenting the text announcement message onto a display;
instructions for converting the text information into a voice announce message and instructions for playing the voice announcement message; and
instructions for converting the voice information into a voice announcement message and instructions for playing the voice announcement message.

35. The computer readable medium of claim 28, wherein the fifth set of instructions for outputting the position information comprise:
instructions for generating a map around the position on the basis of the position information;
instructions for presenting the map on a display; and
instructions for highlighting the position of the called mobile terminal on the map.
